(19) United States
(12) Patent Application Publication
(10) Pub. No.: US 2006/0210681 A1
(43) Pub. Date: Sep. 21, 2006

(54) Method of adorning foodstuff

(76) Inventor: Lewis Churnick, Williston, FL (US)

Correspondence Address: ROBERT M. SCHWARTZ, P.A., P.O. BOX 221470, HOLLYWOOD, FL, 33022, US

(21) Appl. No.: 11/437,562

(22) Filed: May 19, 2006

Related U.S. Application Data
(63) Continuation-in-part of application No. 11/019,997, filed on Dec. 23, 2004, now abandoned.
(60) Provisional application No. 60/606,108, filed on Sep. 1, 2004.

(51) Int. Cl. A23G 3/28

(52) U.S. Cl. 426/383

(57) ABSTRACT

A method of decorating the surface of foodstuffs with photos or images using edible media that maintains the integrity of the photo and remains edible and palatable over prolonged exposure to the surface of the foodstuff.

### INDEX TO RELATED APPLICATIONS

This application is a continuation-in-part of U.S. patent application Ser. No. 11/019,997 filed Dec. 23, 2004, which claims the benefit, under 35 U.S.C. 119(e), of U.S. Provisional Patent Application Ser. No. 60/606,108, filed on Sep. 1, 2004. The prior applications are herewith incorporated by reference in their entirety.

### BACKGROUND OF THE INVENTION

Any person who has ever prepared food for others will tell you that the presentation of the food can be as important as the taste. Professionals and novice chefs alike are continually attempting new ways to create unique presentations and still provide food that tastes good. The method of the present invention is contemplated to be used with any foodstuff. An area that has received particular attention of chefs is the preparation of desserts. The chef sees this as the final opportunity for the diner to see their creativity and craft. There have been numerous items that have been developed for decorating foodstuffs. U.S. Pat. No. 5,017,394 issued to MacPherson relates to a method of manufacturing at least one edible base shape having at least one edible pictorial image thereon wherein the base is formed, dried, at least one edible pictorial image is screen printed onto the edible base. This method is not preferred because the screen printing of the image does not allow for photo quality images or customized photos to be used. The method in the MacPherson patent is further limited in that a different print screen must be created for each image desired.

PCT Patent Application WO 95/01735 to Stuart also describes an edible film. The film of Stuart also has several drawbacks. The formulation requires the film undergo a drying time of 12-14 hours, and is admitably delicate. Further, the Stuart application does not allow for the use of edible photo quality ornamentation. Improvements in resiliency of the film and crisp reproduction of a photograph onto an edible film are neither contemplated nor disclosed by Stuart.

Pullulan films have been described as being suitable for decoration foodstuffs (Food Engineering, 56(11) 88, 1984). However, the film requires heat to apply and dissolve. This would not be usable on a cold or frozen desert, as it would melt the foodstuff. Also, the Pullulan Film is transparent and is not be capable of carrying high-resolution photographic images.

Tague Technologies (www.tastfotoart.com) has a product using wafer paper. Wafer paper has no supportive backing and has limited or nonexistent capability for blending with dessert toppings. The wafer paper does not produce a lasting, crisp photo image. Often, when the wafer paper is exposed to prolonged contact with moisture, it creates a plasticized film that is unpalatable and is often removed by the consumer and not eaten as part of the desert. The Tague web site states: “If you plan to use a whipped cream or other icings with a lot of water, we recommend coating the back with piping gel to seal out the water.” Thus the product has limitations that are prohibitive in various food decorating environments.

There is a need for a method to produce a product which can receive and retain a photo quality image from an ink jet printer where such product will remain both with a crisp image and will be pleasant and palatable over prolonged contact with the foodstuff it contacts.

The inventive method involves the creation of decorative edible items from selected images. The images are unique or personalized pictorial, graphic images or text emblems of an edible nature such as photographs. The graphic images are produced economically, efficiently and cost effectively, by means of printing on an edible media created in such a manner that it can have imagery applied in a variety of methods including, but not limited to stamped impressions logos, hand-drawn images, ink jet printing, or photocopier printing. The article may be made in a variety of pre-formed shapes or sizes thus eliminating the need for cutting either before or after the adornment is applied. Said edible media may then be applied in full contact to foodstuffs having a glaze coating, chocolate layer, whipped dairy or non-dairy topping, candy coating or a variety of other viscous coatings (such as meringue) in order to affect a merge or bonding of the image-printed edible media to the foodstuff.

### BRIEF SUMMARY OF THE INVENTION

The imagery to be applied to foodstuff can be obtained by way of various methods such as stamped impressions, logos, and hand drawn items or obtained by photocopiers or scanners and inkjet printers. The method utilizes a semi-automated casting apparatus such as a silk-screen apparatus that accepts precut pages of coated paper as a support backing for the edible media layer. The edible media can be made in a variety of preformed shapes or sizes, multiple counts per backing by virtue of manipulation of patterns during the making, thus eliminating a need for cutting either before or after the adornment imagery is applied.

One aspect of the invention is an article for receiving adornations to be applied to foodstuffs comprising:
(a) a backing;
(b) a receiving layer comprising a dried edible batter.
   The article of has a layer of dried edible batter comprising:
(a) a first base composition of modified corn starch, citric aid, sugar and corn syrup solids;
(b) a second base composition comprising corn syrup, titanium dioxide, and gum Arabic;
(c) a forming composition comprising polysorbate 80, glycerin; and vegetable Oil; and
(d) a solidifying composition comprising microcrystalline cellulose, cornstarch; sodium Hydroxide and clear vanilla flavor.

The article is capable of receiving and maintaining a photo quality image applied with edible ink and reacts with residual moisture on the surface of a foodstuff allowing an image deposed on the surface of said article to blend into the surface of the foodstuff.

In one preferred embodiment, an edible ink composition of the present invention comprises
a base comprising an aqueous-organic solvent system; and
dissolved food grade color.

In a further preferred embodiment, the base is free of dissolved solids and may further comprise propylene glycol.

A further preferred embodiment has the edible ink composition exhibit the characteristics selected from the group consisting of:
pH 4.0-6.0;
specific gravity 1.0-1.2 g/cm³; and
viscosity less than 5 mPa·s.

It is an object of the present invention to provide a formulation for an edible media batter that can be cast through a print screen onto a substrate.

It is another object of the present invention for the batter to cure in approximately 2 hours.

It is another object of the present invention for the cured batter to create a palatable edible substrate.

It is another object of the present invention for the palatable edible substrate to be suitable to receive an image.

It is another object of the present invention for the received image to be from a conventional ink jet printer.

It is another object of the present invention to produce an edible ink formula suitable for use in conventional ink jet printers.

It is another object of the present invention for the edible ink to produce a photo quality image on the edible substrate.

It is another object of the present invention to provide for a method for producing edible adornations whereby the edible substrate and edible ink act in concert to produce a crisp photo quality image that can be transferred to a foodstuff with moisture.

### DETAILED DESCRIPTION OF THE PREFERRED EMBODIMENTS

The method of the present invention involves the steps of preparing a silk screen having the pattern applied thereto in predetermined size or sizes according to the demands of the final size of the foodstuff to which the decoration is to be applied.

It is contemplated that the printed article is applied in full contact to foodstuff. The foodstuff may include, but would not be limited to: cookies with a glaze coating, chocolate layer, whipped dairy or non-dairy topping, candy coating, egg-based/meringue topping, cream cheese topping, piping gel coating, fondant, marzipan, and any combination thereof.

The example is given for illustrative purposes and is not intended to be limiting as to the scope of the present invention.

### EXAMPLE 1

Formula for Edible Media Batter

Measure 2225 g water set aside
Measure
   1. 65 q modified corn starch (Pure Coat);
   2. 4 g Citric Acid granules;
   3. 250 g granulated sugar;
   4. 700 g corn syrup solids 42DE;
Mix items 1-4 dry with whisk.
Add water while stirring.
When water addition is complete, heat the mixture to 150° F. in microwave, (mix once with whisk during heating).
   After desired temperature is reached mix additional amount as needed until all solids are completely dissolved. This mixture is labeled “hot liquid A”.
Measure 1000 g Corn Syrup and place in its own container.
To the corn syrup, add 30 g Titanium Dioxide & 300 g Gum Arabic.
Mix on slow speed until thoroughly smooth. Call this “mixture B”
   Measure:
   1. 40 g Polysorbate 80
   2. 50 g Glycerine; and
   3. 350 g Vegetable Oil, into a single container, mix until a uniform mixture is achieved and set aside. Call this “mixture C”.
      Measure each of the following into separate containers
   1. 850 g Avicel® (microcrystalline cellulose, a preferred grade of Avicel® is LM310 available from FMC Corporation);
   2. 2000 g Corn Starch;
   3. Measure 25 g Sodium Hydroxide (10% solution); and
   4. 35 g Clear Vanilla flavor (available from Flavor Chem Corporation) set aside.
After hot liquid A is prepared, add A to a bowl containing mixture B, mix until uniform mixture is achieved (approx. 2 minutes).
Using a flexible spatula, scrape the sides and bottom of bowl, mix on medium speed for an additional 4 minutes.
Add mixture C to the combined mixture of A and B. To the mixture of A, B, and C add each of the following individually:
Add Corn Starch, mix and scrape sides and bottom of bowl.
Add Cellulose, mix and scrape sides and bottom of bowl.
Add sodium hydroxide solution. Mix for 2 minutes.
Add Vanilla, mix 5 mm.
Check pH level. A desired pH range is from 4.0-6.0.
   Edible Ink Formulae
   The following formula has been tested in Canon Inkjet Printers Models: Pixma Series, ip3000, ip4000, ip5000, ip6000, MP130, MP750, MP760, and MP780
   It is contemplated that the formulations may be modified as needed such that the physical and chemical characteristics are similar to the Original Equipment Manufacturers (OEM) specification for printing ink in various brands of ink jet printers.
   Base Mixture:
1500 ml grain alcohol (190 proof), 1000 ml propylene glycol, 5 gal HOT water (120° F. deg).
*This produces a clear liquid ready for addition of food dye powders
   Magenta:
Add 800 g #3 powder, mix well in 5 gal hot Base Mixture Yellow:
Add 320 g #5 powder, Add 15 g #3 powder, and mix well in 5 gal hot Base Mixture
   Cyan:
Add 650 g #1 powder, mix well in 5 gal hot Base Mixture
   Black:
Hot Base Mix 5 gal
468 g blue #1
380 g red #3
200 g yellow #5
   Print Head Cleaner:
900 ml Simple green (non-toxic detergent, available from Sam's Club)
1000 ml Alcohol (190 proof)
800 ml Propylene Glycol
Heat water to 120 deg. Add 5 gal
   A method of the present invention comprises:
   (a) placing a receiving paper under the screen of a screen printing machine on a vacuum table;
   (b) attaching a 70 micron screen (at 100 strands per inch giving a 65% open screen area);
   (c) attaching two screen printing blades, a spreading blade and application blade, wherein each blade had been modified such that each one has rounded contact edges;
   (d) place the completed edible media batter mixture onto the screen;
   (e) turn on the screen printing machine;
   (f) allow machine to run until desire amount of photo receiving substrate has been deposed on the receiving paper;
   (g) carefully remove paper with photo receiving substrate;
   (h) place substrate in a convection drying unit and allow to cure for 2 hours;
   (i) place dried substrate in the paper tray of an ink jet printer;
   (j) load the ink jet printer with printer cartridges with edible ink;
   (k) initiate a command from a suitable and compatible source for the printer to print;
   (l) remove the printed article from the printer;
   (m) freeze the printed article;
   (n) remove the receiving paper, which acts as a backing, and place the printed substrate on the foodstuff, with the image side facing outward from the foodstuff.

The method may further comprise creating distinct regions on a single receiving paper and placing each distinct region to different foodstuffs. Further, the method also may include the step of allowing the applied decoration to air dry to complete a bonding process.

The suitable and compatible source for commanding printer may be a computer, digital camera or any other means that can send print commands to a printer.

After preparation of the edible media batter, a coating of batter is applied to a backing. The backing acts as a receiving paper, and may be any acceptable food grade material approved for food contact. The receiving paper or backing is placed in the screen printing machine by hand and is aligned by typical marks or tape in predetermined places. The predetermined places typically are in a frame in position below said silk screen on a vacuum table. The vacuum table is a component of the conventional silkscreen press for keeping the backing substrate in proper position securely. The substrate is held in place on the table by a vacuum while a screen with a pattern is lowered into position from above. The edible media batter is spread over the pre-patterned shape opening in the screen by a flexible blade. A second flexible blade then casts the batter through the openings onto the substrate in a metered layer. Patterns can be made in a variety of configurations, special shapes and multiples thus eliminating the need for die cutting or hand cutting at a later time. The special configurations may include multiple regions on a single sheet wherein each region may receive an image.

Then, use the screen printing machine to cast a film onto the backing. A preferred casting will dry to a thickness of approximately 0.005-0.015″ with a most preferred dried thickness of 0.010″.

After the casting step is completed, the coated pages are removed from the machine for drying. In one preferred method of drying, a convection unit is applied consisting of a rack with removable trays. Each tray holds multiple coated pages. A fan is mounted at the bottom of the rack for drawing air downward. The rack is covered by a removable plastic sheeting to effect a ‘chimney’ configuration. An opening is created at the top and covered with a filtering material to control contaminants. This comprises an effective convection drying unit to reduce curing time to 2 hours or less. In a preferred embodiment, the drying takes place at a temperature between 70-90° F. A most preferred drying temperature is 75-80° F. Common dehumidifying units may be employed in the room to further extract moisture from the environment.

The edible media pages are dried until no longer tacky yet still flexible. The present invention represents a significant improvement over prior articles in that typical drying times are approximately two hours.

After drying, the edible media is now ready to receive images by means of stamping, screen printing, hand drawing, photocopying or scanning to an inkjet printer, each method using edible inks.

Another step in the method of applying imagery to foodstuff, after the image is applied is to remove the edible media from the support backing of the substrate. This is done by freezing the substrate to stiffen the edible media. When the backing is flexed the edible media easily separates by peeling away the backing for the subsequent application to foodstuffs. Another method is to oven-dry the media sheet or substrate until stiffness allows easy release.

A final step in the above described method involves applying the printed edible media to foodstuff. This step targets foodstuffs including, as examples, cookies with a glaze coating, chocolate layer, whipped dairy or non-dairy topping, candy coating, egg based or meringue topping, cream cheese topping, piping gel coating, fondant, marzipan or other. In each case the coating will be in a molten or viscous state. The printed edible media is placed on the coating in full contact. The fluid content of the coating is absorbed into the edible media to affect a melt or merging action. The edible artwork is air dried and is then bonded with the confection.

Additionally the method comprises applying said edible media to foodstuffs as dry application to cookies without a coating. In this case, a mist spray of water may be applied prior to placing the printed media. The user only needs to use water sufficient to provide minimal dampness. The water layer will provide the moisture needed to affect the bonding.

Additionally the method comprises applying said edible foodstuffs to meltable articles such as for example a chocolate bar. One may heat the top surface until molten and then apply the edible media to the molten top surface and allow the foodstuff to harden slowly, whereby the edible media will bond to the surface of the chocolate bar. The heat required is used to liquefy the surface of the chocolate, allowing fluid presence to affect bonding. Heat is not a factor in the bonding reaction of the edible media.

Edible inks of the present invention represent improvements over those previously used. Previous formulae comprising corn starch and maltodextrin have limitations that have been addressed by the present invention. Those previous formula tend to cause more clogging of print heads than does the improved formula of the present invention. The edible ink of the present invention comprises a base of alcohol, propylene glycol and water. The edible ink formulation of the present invention also addresses the deficiencies of other edible inks in that the edible ink of the present invention is an improvement over other attempted formulations, to be formulated with specific physical and chemical properties similar to that of printing ink used in ink jet printers.

In one preferred embodiment, these characteristics include:

pH 7.0-9.0
specific gravity 1.0-1.2 g/cm³
viscosity less than 5 mPa·s

Further, compositions comprising corn starch and/or maltodextrins often exhibit particulate dissociation and the particulates are more apt to clog print heads than formulae of the present invention. Another advantage of the present invention is improved reactivity of the finished product with moisture and no need for application with heat.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A method of applying edible ink imagery to foodstuffs comprising the steps of:
(a) placing a receiving paper under a screen of a screen printing machine on a vacuum table;
(b) attaching a print screen to a screen printing machine;
(c) attaching two screen printing blades, a spreading blade and application blade, wherein each blade had been modified such that each one has rounded contact edges;
(d) place a completed edible media batter mixture onto the screen;
(e) turn on said screen printing machine;
(f) allow said screen printing machine to run until desired amount of edible media batter mixture has been deposed on said receiving paper;
(g) carefully remove receiving paper with edible media batter mixture;
(h) dry said;
(i) place receiving paper with dried edible media batter mixture in the paper tray of an ink jet printer;
(j) load an ink jet printer with printer cartridges with edible ink;
(k) initiate a command from a suitable and compatible source for commanding the printer to print producing a printed article;
(l) remove said printed article from the printer;
(m) freeze said printed article;
(n) remove receiving paper from said printed article, which acts as a backing, and place said printed article on the foodstuff, with the image side facing outward from the foodstuff.

2. The method of claim 1, wherein said print screen is a 70 micron screen at 100 strands per inch giving a 65% open screen area.

3. The method of claim 1, wherein said edible media batter comprises a formula that can be dried into a solid that can receive and maintain a photo quality image.

4. The method of claim 3, wherein said solid that can receive and maintain a photo quality image reacts with residual moisture on the surface of a foodstuff and allows the image to blend into the surface of the foodstuff.

5. The method of claim 1, wherein said desired amount of edible media batter mixture deposed on said receiving paper creates a film with a thickness of 0.005-0.015″.

6. The method of claim 1, wherein said drying is for approximately two hours and occurs in a forced air oven at a temperature of 70-90° F.

7. The method of claim 1, wherein the base mixture of said edible ink is an aqueous-organic cosolvent free of dissolved solids.

8. The method of claim 1, wherein the base mixture of said edible ink further comprises propylene glycol.

9. The method of claim 8, wherein said edible ink exhibits the characteristics selected from the group consisting of:
(a) pH 4.0-6.0;
(b) specific gravity 1.0-1.2 g/cm³; and
(c) viscosity less than 5 mPa·s.

10. The method of claim 1 including the step of applying a mist spray of water to a surface of said foodstuff prior to placing said edible media thereon.

11. The method of claim 1, wherein said printed article is applied in full contact to foodstuff selected from the group consisting of: cookies with a glaze coating, chocolate layer, whipped dairy or non-dairy topping, candy coating, egg-based/meringue topping, cream cheese topping, piping gel coating, fondant, marzipan, and any combination thereof.

12. The method of claim 1, wherein said print screen produces more than one distinct region on said receiving paper for printing an image.

13. The method of claim 1, wherein said drying of said receiving paper with edible batter is by air drying.

14. The method of claim 1 including the step of heating a top surface of said foodstuff until molten prior to placing said edible media order thereon.

15. An article for receiving adornations to be applied to foodstuffs comprising:
(a) a backing;
(b) a receiving layer comprising a dried edible batter.

16. The article of claim 15, wherein said dried edible batter comprises:
(a) a first base composition of modified corn starch, citric aid, sugar and corn syrup solids;
(b) a second base composition comprising corn syrup, titanium dioxide, and gum arabic;
(c) a forming composition comprising polysorbate 80, glycerin; and vegetable Oil; and
(d) a solidifying composition comprising microcrystalline cellulose, corn starch; sodium Hydroxide and clear vanilla flavor.

17. The article of claim 15, wherein said article is capable of receiving and maintaining a photo quality image applied with edible ink.

18. The article of claim 15, wherein said article reacts with residual moisture on the surface of a foodstuff and allows an image deposed on the surface of said article to blend into the surface of the foodstuff.

19. An edible ink composition comprising:
a. a base comprising an aqueous-organic solvent system;
b. dissolved food grade color.

20. The edible ink composition of claim 19, wherein said base is free of dissolved solids.

21. The edible ink composition of claim 19, wherein said ink exhibits the characteristics selected from the group consisting of:
a. pH 4.0-6.0;
b. specific gravity 1.0-1.2 g/cm³; and
c. viscosity less than 5 mPa·s.

22. A composition for forming a substrate for use in adornation of foodstuffs wherein said composition comprises an edible batter comprising:
a. a first base composition of modified corn starch, citric aid, sugar and corn syrup solids;
b. a second base composition comprising corn syrup, titanium dioxide, and gum Arabic;
c. a forming composition comprising polysorbate 80, glycerin; and vegetable Oil; and
d. a solidifying composition comprising microcrystalline cellulose, corn starch; sodium Hydroxide and clear vanilla flavor;
wherein said composition, when dried, is suitable for receiving a photo quality image, and further wherein said photo quality image maintains clarity and integrity upon prolonged exposure to moisture.

23. The composition of claim 19, wherein said dried composition effectuates a blending of said photo quality image onto the surface of a foodstuff when moisture is present.
